(19) United States
(12) Patent Application Publication
(10) Pub. No.: US 2018/0181928 A1
(43) Pub. Date: Jun. 28, 2018

(54) PHYSICAL SENSOR DATA ENABLEMENT OF APPLICATION FUNCTIONALITY USING REAL-WORLD DEVICE CONTEXTS

(71) Applicant: PAYPAL, INC., San Jose, CA (US)

(72) Inventor: Titus Woo, San Jose, CA (US)

(21) Appl. No.: 15/392,298

(22) Filed: Dec. 28, 2016

(51) Int. Cl. G06Q 20/10; G06F 3/0346; G06Q 20/32

(52) U.S. Cl. CPC G06Q 20/102; G06Q 20/3224; G06F 3/0346

(57) ABSTRACT

There are provided systems and methods for physical sensor data enablement of application functionality using real-world device contexts. A computing device of a first user may include sensors, applications, and other components that detect real-world conditions nearby the computing device. Such components may therefore detect location, sound, motion, and other physical conditions. However, the data detected by the computing device may be underutilized where the computing device does not know how to correctly handle and interpret the data. Thus, through processing the real-world context of the data and the device at the time of detection, device actions may be executed. For example, the first user may interact with a second user in the real-world environment, where the device may determine that the users are associated in the real-world environment through the device components and automatically execute processes required by the first user with the second user.

### TECHNICAL FIELD

The present application generally relates to physical sensor data, captured by a real-world device, which can be used to trigger particular functionality in an application. In some instances, physical sensor data and its context can cause automatic population of data in a graphical user interface.

### BACKGROUND

A computing device may have various physical sensors that detect real-world conditions proximate to the device. Among other qualities, location, sound, and proximity to other objects can be sensed and detected. Without recognition and handling of particular sensor data provided for a computing device, however, opportunities for the device to take automatic actions may be overlooked or otherwise ignored. These previously overlooked actions may, depending on the physical real-world context of a particular computing device, save resources for the device such as battery power, computing and memory utilization, wear and tear on input mechanisms, and additionally provide time savings and other benefits to a user of the computing device.

### BRIEF DESCRIPTION OF THE DRAWINGS

FIG. 1 is a block diagram of a networked system suitable for implementing the processes described herein, according to an embodiment;

FIG. 2A is an exemplary environment having a first user utilizing a communication device to engage in transaction processing with a second user based on contextually similar detected device data between the first user and the second user, according to an embodiment;

FIG. 2B includes exemplary interfaces of a first communication device of a first user and a second communication device of a second user when automatically populating contact information for the second user to the first communication device based on contextually similar detected device data between the first user and the second user, according to an embodiment;

FIG. 3 is an exemplary system environment showing a first communication device and second communication device having data used when automatically populating contact information to the first communication device based on contextually similar detected device data between the first user and the second user, according to an embodiment;

FIG. 4 is a flowchart of one embodiment of a process relating to automatic population of application data using contextual similar real-world data captured by devices, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Users may engage in real-world interactions with other users in various embodiments, where the real-world interaction may require an associated payment or transfer. For example, friends and/or family may eat together or go shopping, where one member of the group pays for a transaction and desires reimbursement from one or more other members of the group. Similarly, other users may physically interact and wish to transfer money to another user, for example, in the case of a sale of goods between two users or where users may wish to provide a gift, repayment, or other fund transfer to the other user. These users may utilize mobile computing devices, such as smart phones, to access one or more transaction processing applications to process transactions between users, such as payments and/or transfers.

However, such applications may have interfaces that require the input of multiple data fields, browsing of contact lists to find other users, and/or other laborious processes that may cause additional friction in processing transactions, which may deter users from use of the applications or reduce consumer satisfaction of the users with the applications. Thus, previous solutions to electronic transaction processing may suffer from issues of linking electronic transactions between user accounts and discovery of other users' identifiers for retrieval of account information.

Thus, provided herein are methods and techniques that can be utilized for automatic population of application data using contextual similar real-world data captured by devices. Systems suitable for practicing methods of the present disclosure are also provided.

According to various embodiments, a first user may utilize a first communication device while performing real-world actions or interactions with a second user, for example, during a meal or shopping session at physical merchant locations, a sale of goods between the users, or other type of event where the first and second users may wish to transfer funds between the users and/or provide a payment from one user to the other. Thus, first and second users may have a real-world association that involves a payment or transfer between the users to be processed and completed. Similarly, the second user may also utilize a second communication device. The communication devices may correspond to mobile computing devices, including smart phones, wearable devices, and/or tablet computers. Thus, the first and second users may take the devices with them, such as on their person or nearby, where the devices are capable of collecting data of or associated with the first and the second users.

The first user may utilize the first communication device in possession of the first user to enter a processing request or perform another processing interaction using the first communication device. The processing request may be associated with a transaction processing application, and may signal an intent of the first user to utilize the transaction processing application to process a transaction (e.g., transmit a payment/transfer request or engage in some other payment/transfer process) with at least one other user. For example, the processing request may correspond to a request to execute an application (e.g., open the application or bring to the forefront of an operating system interface), perform a process within the application (e.g., contact lookup, initiate a payment/transfer commend or process), or engage in a process/functionality of the device that is associated with the application (e.g., capture an image in the application using a camera of the device, utilize the device's communication components to communicate with another device or a network, or otherwise utilize device processes/functionalities within the application). Other types of processing requests may include performing a device computing action set for the application (e.g., a double tap or other finger motion/input configured to execute a specific application process), a transaction request in the transaction processing application (e.g., a payment or transfer request to another party within the application), or a contact lookup request in the transaction processing application (e.g., accessing a contact list and/or typing of a name for a contact). Such processing requests may therefore correspond to an executable process for the device operating system and/or the transaction processing application.

The processing request may be utilized to determine that the user wishes to perform an action or execute a process within the application that may involve one or more other users, for example, processing a transaction (e.g., a payment or transfer) with the other users. However, previously solutions do not provide the first user with intelligent selection and automatic population of contact information for other users that the first user wishes to process the transaction with. For example, a problem with conventional solutions is that the first user is required to enter in an identifier or other identification input to select the other users with which the first user wishes to engage in an in-application interaction, which causes additional application friction, additional input commands, and slower application usage. Moreover, such problems may be further compounded by input errors and incorrect user identifier lookup by the application.

In contrast to such issues, a physical and/or real-world connection between the first user and one or more other users, such as the second user, may be determined. In order to determine whether an association or other connection between the first and the second exists, detected device data or another device parameter determined or captured by the first communication device of the first user and/or the second communication device of the second user may be utilized. For example, detected device data for the first user and/or second user may correspond to one or more of a text message, voice data of the first and/or the second user, a motion of the first and/or second user, a biometric of the first and/or second user, pairing of the first communication device to the second communication device through a short range wireless connection, and/or a location determined by the first and/or second communication device for the first and/or second user. In this regard, the second user may be associated with the first user based on contextually similar data captured by the first and/or second communication devices, where the data is used to determine that the first user and the second user have an association. Examples of associations that may be made based on shared data and/or data captured of both the first user and the second user may be sharing a location, having voice data captured of the first and second users, an image captured and/or posted to a social media/sharing platform of the first and second users, shared biometrics (e.g., similar heart rates while exercising, same step/distance traveled, etc.), a shared connection between the first and second communication devices, a connection to the same device over a short range wireless connection (e.g., connecting to the same WiFi router), or other types of shared data between the first user and the second user detected by the first communication device and/or the second communication device.

Thus, an association may correspond to a physical connection between two user, for example, by occupying the same real-world location, performing an action together in the location, engaging in a transaction with each other or purchasing items in a transaction together from another user or merchant, or otherwise physically interacting such that the first user and the second user are connected and may wish to further interact with each other through one or more applications executing on devices of the first user and/or second user. The real-world or physical association may include having matching geo-locations for the first user and the second user, which may correspond to the same physical location (e.g., address, home, merchant location, venue, shopping place, or other place of interaction). The geo-locations may be detected through one or more of the aforementioned device components or applications. The geo-locations may be matched or shared between the first user and the second user by having a first geo-location of the first user be within a set proximity or distance to a second geo-location for the second user. The proximity or distance required to determine the first geo-location matches or is shared with the second geo-location may depending on the physical merchant location, the time of day, the first user and the second user, and/or the type of interaction between the first user and the second user, which may be set by the computing device system, transaction processor service, and/or the first/second users. Moreover, the geo-locations may be required to be shared for a set amount of time to prevent matching the first and second users where the first and second users merely pass by each other and are not interacting. The first user and the second user may therefore co-locate within the real-world at a physical location by having the same or similar geo-locations or other detected physical location of the first user and the second user for required matching parameters.

Additional types of associations may also be determined through other types of device data having similar parameters, timestamps, shared locations, or other types of metadata. For example, an action may be performed by the second user with the second communication device at a same or similar time to the processing request by the first user using the first communication device. The action may correspond to picking up the second communication device to access a transaction processing application and provide a repayment to the first user, or may include other actions that may link the first and second users, including leaving a table after payment of a bill by the first user, placing the second communication device in a pocket or bag at the conclusion of the bill, or other action that indicates that the second user is engaged in a physical or real-world activity or association with the first user. Other types of detected device data may include on device applications, including unlocking or powering on of the second communication device, accessing an application (e.g., the transaction processing application and/or a web browser that may access a transaction processor service), input to the second communication device, and/or other type of executable processes performed by the second user using the second communication. Moreover, the detected device data may be processed to determine the second user is interacting with another user, where the first user may be determined using additional detected device data (e.g., a location, payment, etc.). For example, where voice data of the second user includes a statement of repayment, the second user may wish to repay the first user based on a shared location and a simultaneous payment by the first user. The data may be captured by the second communication device, including through a gyroscope, accelerometer, or other motion detection, a camera, a keyboard/mouse/touchscreen, a microphone, an application executing on the device (e.g., a calendaring, messaging, or other application having application data) or other type of device component.

In various embodiments, a transaction history of a processed transaction by the first user may also be used to determine that the first user has a physical or real-world association with another user, including the second user, which may further be used to determine the second user alone or using the detected device data. For example, a transaction history may indicate a second purchase (e.g., two meals at a dinner) or a purchase exceeding the first user's normal expenditure. Moreover, a transaction history may include names or other identifiers of the transaction participants, such as the first and/or second users. The transaction history may be retrieved from an online transaction processor, such as PAYPAL®, VENMO®, or other electronic transaction processor, as well as additional online resources and backend transaction processing services, including banks and other financial institutions, credit cards, gift card provides, or other resources storing transaction histories. Utilizing the transaction history (e.g., bill, receipt, or bank/credit card statement), it may be determined that the first user is associated with a second user during the transaction. In this regard, the transaction histories of the first user may be processed after the time of the transactions, for example, days, weeks, or months later, to determine if the first user interacted with the second user in a real-world location or otherwise had a physical association, and determine potential payment/transfer requests desirable to the first user that may have been forgotten or previously ignored by the first user. Thus, if the first user forgets to request a payment/transfer with the second user, the first user may be reminded of the transaction (e.g., with a statement such as “Did you purchase from Merchant A? Settle with additional users now.”), and may enter back into the flow described herein to automatically load the additional users' contact information (e.g., the second user's contact information).

In order to determine that the first user was associated with the second user at the time of the transaction for a transaction history, stored data may be utilized as described above, including a library of images having timestamps or other metadata associated with the time/location of the transaction, detected data at the time of the transaction (e.g., locations, messages, voice data, etc.), online posts including social networking data (e.g., a post that indicates the first user is associated with the second user, such as a check-in, wall post tagging the first and/or second user as co-located or together at the time of the transaction, etc.), or other stored data. Thus, utilizing such matching, past transactions of the first user may also be associated with a second user and processed as further described herein. In various embodiments, such processing of statements and past transactions may occur by the transaction processing application, or may occur remotely from the first user's device by the transaction processing service at the time of the transaction or at some later time.

Additionally, the user may also capture an image of a receipt of a transaction, where details of the transaction may be extracted using imaging processing (e.g., optical character recognition (OCR)). In such embodiments, names, amounts, and/or other data for the transaction may be extracted, which may be used to determine whether the first user and the second user have a physical or real-world association. For example, the transaction processing application may allow for capture of images and extraction of image data using one or more image processing techniques (e.g., OCR, image recognition/matching, etc.). In other embodiments, the image may be captured and stored to another application, where the transaction processing application may access the image from a database or the other application. Similar to the processed described above in reference to past transaction histories available through a transaction processor service, the imaged transaction history may be processed at a later time, for example, days, weeks, or months later, so that transactions shared with one or more other users may be linked to the other users and allow the first user to recall and send a payment/transfer request. Thus, the transaction processing application may scan stored images to one or more resources, including online resources (e.g., media sharing, social networking, or image storage platforms), to locate transaction histories, determine whether the transactions are shared with additional users (e.g., the second user), and match the transaction to the additional users.

Thus, based on the processing request and the connection/association between the first user and the second user, the first user may be determined to be requesting or desire to request an application interaction with the second user. In this regard, the processing request by the first user may be linked to the second user in the transaction processing application based on the detected device data that indicates a physical or real-world association or connection between the first user and the second user. Thus, the physical or real-world association or connection may be determined by the transaction processing application and/or a backend transaction processing service without automatically and/or without user input in order to load or populate contact information for the second user to an interface of the transaction processing application on the first communication device. In order to retrieve the contact information for the second user, an identifier used for identification of the second user (e.g., in the transaction processing application) may be determined based on the determination that the first user is associated with the second user using the detected device data. The identifier may correspond to a name, phone number, email address, or other sequence of characters, numbers, and/or symbols that uniquely identifies the second user. Thus, the identifier allows for identification of the second user within the transaction processing application. The identifier may be determined by the first communication device based on the association between the first user and the second user, or may be determined by a service, such as a transaction processor service or a third party service used by the first user and/or first communication device.

Using the identifier, contact information for the second user may be retrieved. The contact information may be stored to one or more of a database of the first communication device, a contact list application used by the first user, a social networking account of the first user, prior contacts of the first user, and/or additional contacts known to the prior contacts of the first user (e.g., “friends of friends,” including shared social networking contacts or other connections). Thus, the contact information may be stored to an on-device resource or another disparate resource, such as an online resource. The contact information may include at least information necessary to process an application interaction by the first user with the second user. For example, the contact information may include a name, address, phone number, or other information allowing for transmission of a payment or transfer request to the second user. In other embodiments, the contact information may correspond to an account identifier, such as an identifier for a payment account of the second user used for sending and/or receiving payments and/or transfers. Thus, the contact information may include necessary information for input to a transaction request interface and/or loading for selection by the first user to initiate a transaction request.

Once the contact information is determined, it may be automatically loaded or populated within the transaction processing application to the first user on the first communication device. Loading or populating the contact information may include highlighting or presenting the contact information or application profile for the second user to an interface of the transaction processing application, which allows the first user to select the second user's contact information for entry to the interface form for the transaction request (e.g., a payment or transfer request to the second user). Such loading or populating to the interface may also include suggesting the contact information to the first user, for example, through a “Did you want to select the Second User?” or similar terminology and interface display, including popup messages, highlighting, auto scrolling, or other notification technique. Thus, on selection of the notification for the second user's contact information, the second user's contact information may be loaded to the interface form. In other embodiments, the second user's contact information may be automatically populated into the interface form. The interface form may also allow for the first user to enter additional information, such as an amount for the request (e.g., a requested amount to be paid by the second user to the first user or by the first user to the second user). The amount may be filled using user input. The first user may also add additional information, such as a message, one or more emojis, information for a wall or feed of the transaction processing application or another service, or other information the first user may associate with the request.

In various embodiments, the additional information entered to the interface form or other application field may be automatically filled based on information accessible or retrievable by the transaction processing application. For example, a transaction history may be used to determine a cost of the transaction, and apportion cost between the first user and the second user, such as a direct split of the transaction or an itemized bill where one or more items can be automatically or manually assigned to one or more parties. A predictive algorithm/process may be utilized to determine which items are for the first user and/or the second user using past purchases, interests, messages, or other information. In other embodiments, the transaction history may be itemized into each item, where the first user can select one or more items to assign to the second user in the interface, for example, by selecting items purchased for or consumed by the second user. Thus, the amount may also be filled based on a known transaction history, as previously discussed. The transaction history may be retrieved from an online service, such as the transaction processor service, or from imaging of the receipt, as discussed herein.

In various embodiments, more than one user may be determined. For example, the first user may wish to make or receive a group payment or transfer to more than one individual user. Thus, and similar to as discussed above, a plurality of users may be determined to be associated with the first user in a physical or real-world setting, and thus the first user is performing a processing request with the first communication device to interact with more than one of the users with the transaction processing application. For example, more than just the second user may be co-located with the first user, or otherwise may be detected as nearby the first user, and accessing their mobile computing devices at the same time as the first user to provide repayment. Thus, it may be determined that all the matching users are further associated with the first user, and the first user may be requesting an application interaction or process with all of the users. The plurality of users may be presented to the user with their contact information using identifiers for the plurality of users, which may be retrieved in response to determining that the first user and multiple other users have an association. The first user may then be allowed to select one or more of the plurality of users, including the second user and any additional users to be added to the transaction request or may select all users to be added. In various embodiments, the selection of all of the plurality of users to add to the transaction request may occur automatically. In various embodiments, the aforementioned predictive algorithm or process may be utilized to determine whether a transaction history of the first user involves more than one other user (e.g., the plurality of other users sharing in the transaction) based on the information in the transaction history. In this regard, the predictive algorithm may determine that more than one other user shared in the transaction based on a type and/or a number of items in the transaction, a cost of the transaction, a time of the transaction, and/or other information in the transaction history. For example, if a receipt includes five different dinner items, it may be determined that the first user requires repayment from four other users. Other items may be ignored depending on significance, such as a number of drinks being insignificant compared to an entrée item in a transaction history. As discussed herein, the transaction history information may be retrieved from an online resource, or may be extracted from data in an image captured of the transaction history.

Thus, once contact information and any additional information for the transaction request (e.g., a request for a payment or transfer) is loaded/entered to the transaction request (e.g., populated through one or more electronic forms presented through an interface of the transaction processing application), the transaction processing application may process the request. Processing the request may utilize a transaction processing service, such as an online service provider. The transaction processing service may allow two or more entities (e.g., personal users, groups of users, merchants, etc.) to engage in electronic processing for a transaction (e.g., a payment or transfer between the first user and the second user). The service provider may further provide additional types of services, including account services and digital wallet service, for example, to store one or more financial instruments of the appropriate user for use in transaction processing and provide a digital wallet that may be utilized to perform transaction processing through tokenized payment services.

In this regard, the first and/or second user may further be required to establish an account with the service provider in order to engage in transaction processing. The appropriate user may be required to provide personal, business, or other identification information to establish the account, such as a name, address, and/or other information. The appropriate user may also be required to provide financial information, including payment cards (e.g., credit/debit cards), bank account information, gift cards, and/or benefits/incentives, which may be utilized to provide payments or otherwise engage in processing of another transaction. In order to create an account, the appropriate user may be required to select an account name and/or provide authentication credentials, such as a password, personal identification number (PIN), security questions, and/or other authentication information. The service provider may utilize such information to create the account for the appropriate user, and provide the appropriate user with a digital wallet that allows for electronic transaction processing. The digital wallet may store the appropriate user's financial instruments and allow the appropriate user to process transactions through the digital wallet. In this regard, the service provider may provide a digital token to a device (e.g., the first or second communication device), such as a data packet, that represents the digital wallet and may approve the appropriate user for use of digital wallet for processing of a transaction with the service provider. Thus, the token may include data identifying the digital wallet (e.g., a token), as well as authentication information including an identifier for use of the digital wallet, which may be encrypted. The token may also correspond to a non-sensitive data element that also allows identification of appropriate information for processing the transaction, which may be presented by the first or second user during transaction processing to process the transaction (e.g., provide the payment/transfer, or request the payment/transfer to the associated account/digital wallet).

Once an account is created, the account may be accessed through a web browser from a website of the service provider and/or a dedicated application of the service provider, such as a mobile smart phone application. The first and/or second users may engage in transaction processing through accessing their respective account and processing a transaction based on the contact information for the other user and/or additional transaction information. Thus, the aforementioned token may be issued to the respective user for their respective accounts, where the token may include data (which may be encrypted) allowing the service provider to identify the user and their account, as well as authenticate the user. As such, the token may be transmitted to other entities during transaction processing, which may allow the service to identify and authenticate the user's account and engage in transaction processing. Thus, the accounts may store information associated with each user for use in transaction processing.

In this regard, a computing device for a user (e.g., the first or second user), such as the first or second communication device, may further include a mobile payment application or more generally a transaction processing application, which may be configured to send and receive payments to another party, as described herein. In various embodiments, a website may provide the transaction processing services, and thus may be accessed by a web browser application. The application (or website) may be associated with a payment provider, such as PayPal® or other online payment provider services, which may provide payments and the other aforementioned transaction processing services on behalf of the users. The application may execute on the computing device for the first and/or second user, and may provide various functionalities and processes to the user. As discussed above, the first user may generate the transaction request using the automatically populated contact information and transmit the transaction processing request to the second user to receive a payment or transfer from the second user.

As described herein, the first user may also wish to repay the second user (instead of request a payment from the second user) after the second user has performed some transaction that includes the first user. Thus, similar to the above, the first user may instead utilize the application to send a payment to the second user instead of sending a payment request to the second user. Where a payment request has previously been generated by the second user, the first user may utilize the application to view the request. In further embodiments, the payment request may be brought to the top of a queue or otherwise highlighted to the first user based on contextually similar data, for example, where the first user views their phone while the second user is transmitting the request and is co-located with the second user. However, if the second user has not yet sent the request, the first user may send the payment using the processes described herein to determine that the first user is associated with the second user and that the first user wishes to process a transaction with the second user (e.g., using contextually similar detected device data). However, the first user may also transmit a request or process a request at a different time, for example, after returning from a meal with the second user. In such embodiments, the previous contextually similar data may be used to determine that the first user and the second user had an interaction at a previous time (which may be associated with a previously processed transaction by the transaction processing application or using another payment mechanism), and that the first user may wish to process a transaction with the second user.

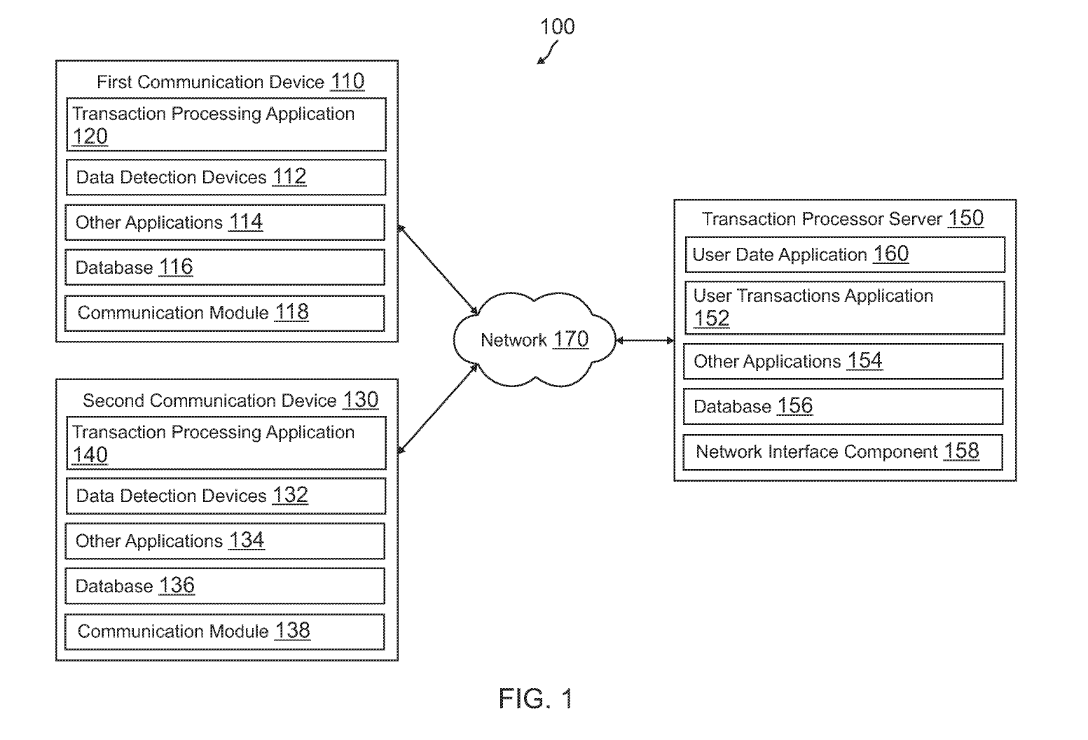

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a first communication device 110, a second communication device 130, and a transaction processor server 150 in communication over a network 170. The first user (not shown) may utilize first communication device 110 to utilize the various features available for first communication device 110, which may include processes and/or applications associated with transaction processor server 150 to process a transaction (e.g., a payment or transfer) with the second user (not shown) associated with second communication device 130. In this regard, first communication device 110 may detect a processing request input by the first user to first communication device 110. In response to the processing request, first communication device 110 and/or transaction processor server 150 may further determine that the first user is associated with the second user, and determine an identifier for the second user. The identifier may be used to retrieve contact information for the second user, where the contact information may then be automatically populated to a form, presented within an interface, or otherwise communicated to the first user through an application executing on first communication device 110.

First communication device 110, second communication device 130, and transaction processor server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

First communication device 110 may be implemented as a communication device that may utilize appropriate hardware and software configured for wired and/or wireless communication with second communication device 130, and/or transaction processor server 150. For example, in one embodiment, first communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS ®), other type of wearable computing device, implantable communication devices, and/or other types of computing devices capable of transmitting and/or receiving data, such as an IPAD® from APPLE®. Although only one communication device is shown, a plurality of communication devices may function similarly.

First communication device 110 of FIG. 1 contains a transaction processing application 120, data detection device 112, other applications 114, a database 116, and a communication module 118. Transaction processing application 120 and other applications 114 may correspond to executable processes, procedures, and/or applications with associated hardware. In other embodiments, first communication device 110 may include additional or different modules having specialized hardware and/or software as required.

Transaction processing application 120 may correspond to one or more processes to execute software modules and associated devices of first communication device 110 to process transaction by a first user corresponding to first communication device 110 with one or more other users, which may include payments or transfers to the other users. In this regard, transaction processing application 120 may correspond to specialized hardware and/or software that may intelligently auto-select or auto-populate contact information for one or more specific users to an interface to allow the first user to process the transaction with the other user(s). For example, the first user may wish to process a transaction (e.g., a payment or transfer) with a second user corresponding to second communication device 130. Thus, the first user may utilize first communication device 110 to perform some executable process or enter a processing request for execution by first communication device 110. The processing request may correspond to a request for first communication device 110 to utilize processing resources, including activation of first communication device 110, operating first communication device 110 and/or transaction processing application 120, or performing a process in transaction processing application 120. The processing request may be input through an input device of first communication device 110. Moreover, the processing request may signal the first user's intent to utilize transaction processing application 120 to perform an application interaction or process with the second user corresponding to second communication device 130. For example, the processing request may either be linked to a request to perform a process in transaction processing application 120 (e.g., a transaction, such as a payment or transfer) with the second user or may indicate that the first user may utilize transaction processing application 120 with the second user.

Once the processing request is received, transaction processing application 120 may require data detected using one or more devices that may be processed to determine that the first user is associated with the second user. The detected device data may indicate that the first user and the second user have a physical or real-world association or connection, for example, by sharing similar data or having data that may contextually indicate that the first user and the second user are connected. Thus, transaction processing application 120 may utilize data from one or more of data detection devices 112, other applications 114, database 116, communication module 118, second communication device 130, and/or transaction processor server 150 for determination of the association between the first user and the second user. For example, data detection devices 112 may utilize one or more sensors to capture data, including image data, nearby devices, voice data, motion data, and/or location data. Similarly, data detection devices 112 and/or transaction processing application 112 may interface with an application of other application 114 to receive data, may access stored data from database 116, and/or may detect connections and other device (including second communication device 130) using communication module 118. In various embodiments, transaction processing application 120 may also query second communication device 130 and/or transaction processor server 150 for the data. The data may correspond to detected data that indicates or causes generation of an association between the first user and the second user, for example, by having contextually similar or the same data (e.g., shared data or data that may link the first user and the second user). Once received, the detected device data may then be processed by transaction processing application 120 to determine the physical or real-world association between the first user and the second user.

In various embodiments, the detected device data may indicate that the first user is associated with the second user and one or more additional users, such as a plurality of users. In such embodiments, the first user may have a real-world or physical association or connection with multiple other users, where the detected device data indicates multiple interactions. Thus, transaction processing application 120 may determine multiple associations for a transaction, for example, using a transaction history that indicates that multiple users shared in a transaction (e.g., based on the type, cost, number of items, or other transaction information). In such embodiments, transaction processing application 120 may utilize a predictive algorithm or process to determine whether a transaction history includes multiple other users, for example, based on the type, cost, number of items, or other information. Moreover, transaction processing application 120 may utilize other data, including images, voice data, location data, or other detected device data to determine the identity of the other users. Additionally, transaction processing application 120 may perform such processing at other times than the time of the transaction or a time closely tied to the transaction (e.g., within seconds or minutes after detection of the transaction for the transaction history), for example, hours, days, weeks, or months later, in order to determine whether there was a missed transaction that the first user forgot to request a payment/transfer with the second user.

Transaction processing application 120 may therefore determine that the first user is associated with or connected to the second user based on the detected device data. Thus, after transaction processing application 120 identifies the second user based on the detected device data, transaction processing application 120 may access, retrieve, or otherwise determine an identifier and identifies the second user, for example, within transaction processing application 120 or another application that may be used to retrieve contact information for the second user. Transaction processing application 120 may utilize the identifier to retrieve the contact information for the second user for one or more contact lists having stored contact information for one or more users. For example, the contact list may be associated with a phonebook or contact application, an email or messaging application, a social networking or other online sharing application, and/or from secondary contacts that are associated with the current contacts of the first user. Thus, transaction processing application 120 may retrieve the contact information for the second user using the identifier, which may be populated, filled, entered, or otherwise loaded to a form, interface, or notification for presentation to the first user using transaction processing application 120. In embodiments where multiple users share in the transaction and thus are more than one other user are determined to be associated with the first user in the real-world or physical environment, transaction processing application 120 may determine multiple identifiers for the plurality of users, which may be used to retrieve contact information for all of the plurality of users.

Thus, transaction processing application 120 may display the contact information for the second user in one or more fields, notifications, or interface elements. The contact information may be automatically populated into fields for a transaction request (e.g., a payment/transfer request with the second user). In other embodiments, the first user may select the second user's contact information, which may also be displayed with other matching users determined as described herein. Once the contact information is entered to a transaction request, the first user may provide additional information, such as an amount, whether the amount is requested to be paid from the second user (e.g., if the first user is the requestor/recipient/payee of a payment and the second user is the requestee/giver/payor) or if the amount is to be paid to the second user (e.g., if the first user is the requestee/giver/payor of a payment and the second user is the request requestor/recipient/payee). In various embodiments, the amount may be entered through user input. However, in other embodiments, transaction processing application 120 may include one or more processes to process a transaction history (e.g., a financial statement, receipt, account history, credit card usage, etc.) to determine an amount for the transaction, an apportion the amount correctly. In such embodiments, transaction processing application 120 may split the amount evenly or otherwise apportion the transaction amount, including through itemization of the transaction and allotment of item costs (including tax/tip portions for each item) to the second user. Transaction processing application 120 may include one or more interface options, selectable buttons, or menu options (e.g., drop down menu selections) that allow the first user to attribute an item cost to the second user and generate an amount for the transaction processing request. The first user may also add a message, information to be posted to a wall or feed for social payments/networking, or other information. Once completed, the first user may then submit the transaction request for processing with transaction processor server 150.

In this regard, transaction processing application 120 may also provide transaction processing services, for example, through one or more processes that provide an interface to permit the first user to enter input and other data for payment instruments, for example, through an input device (e.g., touch screen with a graphical user interface, keypad/keyboard, mouse, etc.) and/or through a data capture device (e.g., scanner, camera, other optical device, etc.). Such information may be stored with transaction processor server 150 for use with an online digital wallet stored to an account for the first user with transaction processor server 150, which may be utilized for transaction processing with another entity, such as the second user associated with second communication device 130. In various embodiments, information for the account may also be stored to first communication device 110 for use in an offline environment. The account accessible through transaction processing application 120 may be used to initiate, receive, and/or process/complete transactions using services provided by transaction processor server 150. Once entered, the payment instruments may be communicated to transaction processor server 150 over network 170 by transaction processing application 120 for establishment and/or maintenance/update of the account and/or entry into the digital wallet for the first user. The first user of first communication device 110 may also enter discounts and/or benefits to transaction processing application 120 for storage to the digital wallet and use during transaction processing.

Transaction processing application 120 may utilize one or more user interfaces, such as graphical user interfaces presented using an output display device of first communication device 110, to enable the first user associated with first communication device 110 to perform transaction processing, as discussed herein. In various embodiments, transaction processing application 120 may correspond to a general browser application configured to retrieve, present, and communicate information over the Internet (e.g., utilize resources on the World Wide Web) or a private network. For example, transaction processing application 120 may provide a web browser, which may send and receive information over network 170, including retrieving website information (e.g., a website for transaction processor server 150), presenting the website information to the user, and/or communicating information to the website. However, in other embodiments, transaction processing application 120 may include a dedicated application of transaction processor server 150 or other entity (e.g., a merchant), which may be configured to assist in processing transactions. The interface(s) providing by transaction processing application 120 may be utilized to enter transaction information, which may include the automatically populated contact information for the second user, request processing for the transaction between the first user and the second user, and/or communicate the transaction information and the digital wallet token to second communication device 130 and/or transaction processor server 150 for processing of the transaction.

Data detection devices 112 may correspond to one or more devices utilized for capturing, detecting, and/or determining user data of the first user associated with first communication device 110 and/or the second user associated with second communication device 130. In this regard, data detection devices 112 may correspond to one or more of a location detector and/or associated application (e.g., GPS locator and/or mapping application), a microphone to detect voice data, a camera, one or more motion detectors (e.g., gyroscope, accelerometer, etc.), input devices (e.g., keyboard, mouse, and/or touchscreen), or other type of sensor capable of detecting device data. The camera may be used to capture a receipt or other transaction history and may be associated with OCR and other image processing to extract data from the transaction history, for example, through transaction processing application 120 and/or one or more of other application 114. Data detection devices 112 may also include or utilize one or more other components of first communication device 110, such as communication module 118, to further detect device data, including short range wireless communications with other devices (e.g., second communication device 130, an Internet WiFi router, a Bluetooth or Bluetooth Low Energy (BLE) beacon, or other device) to detect proximate devices and/or associate devices with a location. Other types of interacting components may include other application 114 (e.g., messaging, social networking, microblogging, media sharing, imaging, scheduling or calendaring, mapping, or other type of application in other applications 114 having application data) and/or database 116 having stored past data.

Thus, data detection devices 112 may be utilize to collect the detected device data, user data, and/or other parameters, metadata, or information used to determine that the first user corresponding to first communication device 110 is associated with the second user corresponding to second communication device 130. In other embodiments, one or more of the features of data detection devices 112 may be provided by or utilized with one or more other applications of components of first communication device 110 (e.g., other applications 114, database 116, communication module 118, and/or transaction processing application 120).

In various embodiments, first communication device 110 includes other applications 114 as may be desired in particular embodiments to provide features to first communication device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for first communication device 110 and processes the location information to determine a location of first communication device 110 and the user. Other applications may include social networking applications, media viewing, and/or merchant applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use devices of first communication device 110, such as display devices capable of displaying information to users and other output devices, including speakers. Moreover, other application 114 may be utilized by one or more of data detection devices 112 and/or transaction processing application 120 for determination of detected device data when determining an association between the first user and the second user.

First communication device 110 may further include database 116 stored to a transitory and/or non-transitory memory of first communication device 110, which may store various applications and data and be utilized during execution of various modules of first communication device 110. Thus, database 116 may include, for example, identifiers such as operating system registry entries, cookies associated with transaction processing application 120 and/or other applications 114, identifiers associated with hardware of first communication device 110, or other appropriate identifiers, such as identifiers used for payment/user/device authentication or identification, which may be communicated as identifying first communication device 110 to transaction processor server 150. In various embodiments, account information and/or digital wallet information may be stored to database 116 for use by first communication device 110. Database 116 may also store captured data, including prior and current user data, detected device data, and other types of data. Additionally, database 116 may store identifiers and/or contact information, which may be utilized by transaction processing application 120.

First communication device 110 includes at least one communication module 118 adapted to communicate with second communication device 130 and/or transaction processor server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices (e.g., second communication device 130) using short range communications, such as Bluetooth Low Energy, LTE Direct, WiFi, radio frequency, infrared, Bluetooth, and near field communications.

Second communication device 130 may be implemented as a communication device that may utilize appropriate hardware and software configured for wired and/or wireless communication with first communication device 110 and/or transaction processor server 150. For example, in one embodiment, second communication device 130 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

Second communication device 130 of FIG. 1 contains a transaction processing application 140, data detection devices 132, other applications 134, a database 136, and a communication module 138. Transaction processing application 140 and other applications 134 may correspond to executable processes, procedures, and/or applications with associated hardware. In other embodiments, second communication device 130 may include additional or different modules having specialized hardware and/or software as required.

Transaction processing application 140 may correspond to one or more processes to execute software modules and associated devices of second communication device 130 to process transaction by a second user corresponding to second communication device 130 with one or more other users, which may include payments or transfers to the other users. In this regard, transaction processing application 140 may correspond to specialized hardware and/or software that may receive a transaction request and process the transaction, or receive information of a processed transaction and display the information to the second user. As discussed herein, a first user associated with first communication device 110 may wish to process a transaction (e.g., a payment or transfer) with the second user, and may have contact information for the second user automatically and/or intelligently loaded to first communication device 110 based on detected device data available from one or more of first communication device 110, second communication device 130, and/or transaction processor server 150. Thus, the first user may utilize first communication device 110 to submit the transaction request for processing with transaction processor server 150, as discussed herein. Once submitted, the second user may utilize transaction processing application 140 to process the transaction request and/or view the results of the transaction.

In this regard, transaction processing application 140 may provide transaction processing services, for example, through one or more processes that provide an interface to permit the second user to enter input and other data for payment instruments, for example, through an input device (e.g., touch screen with a graphical user interface, keypad/keyboard, mouse, etc.) and/or through a data capture device (e.g., scanner, camera, other optical device, etc.). Such information may be stored with transaction processor server 150 for use with an online digital wallet stored to an account for the second user with transaction processor server 150, which may be utilized for transaction processing with another entity, such as the first user associated with first communication device 110. In various embodiments, information for the account may also be stored to second communication device 130 for use in an offline environment. The account accessible through transaction processing application 140 may be used to initiate, receive, and/or process/complete transactions using services provided by transaction processor server 150. Once entered, the payment instruments may be communicated to transaction processor server 150 over network 170 by transaction processing application 140 for establishment and/or maintenance/update of the account and/or entry into the digital wallet for the second user. The second user of second communication device 130 may also enter discounts and/or benefits to transaction processing application 140 for storage to the digital wallet and use during transaction processing.

Transaction processing application 140 may utilize one or more user interfaces, such as graphical user interfaces presented using an output display device of second communication device 130, to enable the second user associated with second communication device 130 to perform transaction processing and/or view the results of a processed transaction, as discussed herein. In various embodiments, transaction processing application 140 may correspond to a general browser application configured to retrieve, present, and communicate information over the Internet (e.g., utilize resources on the World Wide Web) or a private network. For example, transaction processing application 140 may provide a web browser, which may send and receive information over network 170, including retrieving website information (e.g., a website for transaction processor server 150), presenting the website information to the user, and/or communicating information to the website. However, in other embodiments, transaction processing application 140 may include a dedicated application of transaction processor server 150 or other entity (e.g., a merchant), which may be configured to assist in processing transactions.

The interface(s) providing by transaction processing application 140 may be utilized to populate transaction information for a transaction request (e.g., a payment or transfer request) from the first user. For example, after the first user transmits the transaction request that requires the second user to approve, provide a payment or transfer of funds, and/or respond, the transaction request may be populated within an interface of transaction processing application 140. The second user may process the transaction by approving or denying the transaction request, providing a payment instrument or digital wallet token, and/or requesting processing of the transaction based on the provided information. In various embodiments, the second user may be able to or required to enter information to the transaction request, such as a message, amount, or other information. The transaction request may be displayed with transaction information, including identification of the first user, the amount, a message, a timestamp, or any additional transaction information. In certain embodiments, the second user may also be able to perform intelligent lookup of contact information for the first user and/or the transaction request using contextually similar data detected by one or more devices similar to the processes as described herein in reference to transaction processing application 120 of first communication device 110. For example, the transaction request may include the detected device data necessary to connect the first user to the second user, which may be used with data determined by data detection devices 132 to highlight the transaction request to the second user in an interface or otherwise notify the second user of the request. In additional embodiments where the transaction corresponds to a payment or transfer of funds to the second user from the first user, transaction processing application 140 may instead provide an interface where the second user may view a notification, account balance, or other information indicating the status of the processed transaction (e.g., pending, approved, denied) and/or additional information for the transaction (e.g., a message, amount, etc.).

Data detection devices 132 may correspond to one or more devices utilized for capturing, detecting, and/or determining user data of the first user associated with second communication device 130 and/or the second user associated with second communication device 130. In this regard, data detection devices 132 may correspond to one or more of a location detector and/or associated application (e.g., GPS locator and/or mapping application), a microphone to detect voice data, a camera, one or more motion detectors (e.g., gyroscope, accelerometer, etc.), input devices (e.g., keyboard, mouse, and/or touchscreen), or other type of sensor capable of detecting device data. Data detection devices 132 may also include or utilize one or more other components of second communication device 130, such as communication module 138, to further detect device data, including short range wireless communications with other devices (e.g., second communication device 130, an Internet WiFi router, a Bluetooth or Bluetooth Low Energy (BLE) beacon, or other device) to detect proximate devices and/or associate devices with a location. Other types of interacting components may include other application 114 (e.g., messaging, social networking, microblogging, media sharing, imaging, scheduling or calendaring, mapping, or other type of application in other applications 134 having application data) and/or database 136 having stored past data. Thus, data detection devices 132 may be utilize to collect the detected device data, user data, and/or other parameters, metadata, or information used to determine that the first user corresponding to second communication device 130 is associated with the second user corresponding to second communication device 130. In other embodiments, one or more of the features of data detection devices 132 may be provided by or utilized with one or more other applications of components of second communication device 130 (e.g., other applications 134, database 136, communication module 138, and/or transaction processing application 140). Data detected by data detection devices 132 may be provided to one or more of first communication device 110 and/or transaction processor server 150 for use in determining the association between the first user and the second user by first communication device 110 when automatically populating the second user's contact information to transaction processing application 120 of first communication device 110.

In various embodiments, second communication device 130 includes other applications 134 as may be desired in particular embodiments to provide features to second communication device 130. For example, other applications 134 may include security applications for implementing client-side security features, programmatic client applications for interfacing with appropriate application programming interfaces (APIs) over network 170, or other types of applications. Other applications 134 may also include email, texting, voice and IM applications that allow a user to send and receive emails, calls, texts, and other notifications through network 170. In various embodiments, other applications 134 may include financial applications, such as banking applications. Other applications 134 may also include other location detection applications, which may be used to determine a location for the user, such as a mapping, compass, and/or GPS application, which can include a specialized GPS receiver that obtains location information for second communication device 130 and processes the location information to determine a location of second communication device 130 and the user. Other applications may include social networking applications, media viewing, and/or merchant applications. Other applications 134 may include device interface applications and other display modules that may receive input from the user and/or output information to the user. For example, other applications 134 may contain software programs, executable by a processor, including a graphical user interface (GUI) configured to provide an interface to the user. Other applications 134 may therefore use devices of second communication device 130, such as display devices capable of displaying information to users and other output devices, including speakers. Moreover, other application 114 may be utilized by one or more of data detection devices 132 and/or transaction processing application 140 for determination of detected device data when determining an association between the first user and the second user.

Second communication device 130 may further include database 136 stored to a transitory and/or non-transitory memory of second communication device 130, which may store various applications and data and be utilized during execution of various modules of second communication device 130. Thus, database 136 may include, for example, identifiers such as operating system registry entries, cookies associated with transaction processing application 140 and/or other applications 134, identifiers associated with hardware of second communication device 130, or other appropriate identifiers, such as identifiers used for payment/user/device authentication or identification, which may be communicated as identifying second communication device 130 to transaction processor server 150. In various embodiments, account information and/or digital wallet information may be stored to database 136 for use by second communication device 130. Database 136 may also store captured data, including prior and current user data, detected device data, and other types of data. Additionally, database 136 may store identifiers and/or contact information, which may be utilized by transaction processing application 140. Database 136 may also store incoming transaction requests, as well as associated transaction information for a transaction between the first user and the second user.

Second communication device 130 includes at least one communication module 138 adapted to communicate with first communication device 110 and/or transaction processor server 150. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 138 may communicate directly with nearby devices (e.g., second communication device 130) using short range communications, such as Bluetooth Low Energy, LTE Direct, WiFi, radio frequency, infrared, Bluetooth, and near field communications.

Transaction processor server 150 may be maintained, for example, by an online service provider, which may provide transaction processing and payment services. In this regard, transaction processor server 150 includes one or more processing applications which may be configured to interact with first communication device 110, second communication device 130, and/or another device/server to facilitate recommendation of items between users based on data captured by one of the user, as well as processing transactions for the items. In one example, transaction processor server 150 may be provided by PAYPAL®, Inc. of San Jose, Calif., USA. However, in other embodiments, transaction processor server 150 may be maintained by or include another type of service provider, which may provide connection services to a plurality of users.

Transaction processor server 150 of FIG. 1 includes a user data application 160, other applications 154, a database 156, and a network interface component 158. User data application 160 and other applications 154 may correspond to executable processes, procedures, and/or applications with associated hardware. In other embodiments, transaction processor server 150 may include additional or different modules having specialized hardware and/or software as required.

User data application 160 may correspond to one or more processes to execute software modules and associated specialized hardware of transaction processor server 150 to receive, collect, and/or provide user data and/or detected device data that may be used to determine an association between a first user and a second user. In this regard, user data application 160 may correspond to specialized hardware and/or software to receive user data and/or collect user data based on user processing actions and/or detected device data. For example, user data application 160 may receive detected device data from one or more of first communication device 110 and/or second communication device 130. The user data may be made available to first communication device 110 when determining a physical or real-world associated between the first user and the second user for use in automatic population of the second user's contact information to an interface of transaction processing application 120 executable by first communication device 110. Additionally, user data application 160 may also collect user data, such as account actions, transaction processing requests and processed transactions, and other types of online or network actions and/or processes performed by the first user and/or the second user. The user data may correspond to detected device data, such as device usage, account accesses or updates, account usage, or other type of data that may be communicated over network 170 and detected or received by transaction processor server 150. The data may correspond to the first user utilizing first communication device 110 and/or the second user utilizing second communication device 130. Thus, when determining a physical or real-world association between the first user and the second user, first communication device 110 may request data from user data application 160. In various embodiments, user data application 160 may receive the request with additional data or metadata to compare to stored data for a plurality of users, such as a location for use in narrowing the search for contextually similar data of the other users. Additionally, in other embodiments, user data application 160 may receive detected device data from first communication device 110 that may be compared to stored data by transaction processor server 150 for use in determining the association between the first user and the second user, as discussed herein in reference to transaction processing application 120 of first communication device 110. In various embodiments, user data application 160 may further perform one or more of the processes described herein by reference to transaction processing application 120 of first communication device 110. For example, user data application 160 may process transaction histories and other user detected or stored data to make associations between the first user and the second user, which may include processing after the association and corresponding transaction, such as hours, days, weeks, or months later.

User transaction application 152 may correspond to one or more processes to execute software modules and associated specialized hardware of transaction processor server 150 to provide transaction processing services to the first and second users, for example though an account and/or payment instruments of the users stored in a digital wallet of the account. In this regard, user transaction application 152 may correspond to specialized hardware and/or software to establish one or more accounts, including digital wallets storing payment instruments. The services may allow for payments and/or transfers between the first user and the second user through a payment instrument, including a credit/debit card, banking account, payment account with transaction processor server 150, and/or other financial instrument. In order to establish an account for a user to send and receive payments, user transaction application 152 may receive information requesting establishment of the payment account. The information may include user personal, business, and/or financial information. Additionally the information may include a login, account name, password, PIN, or other account creation information. The user may provide a name, address, social security number, or other personal or business information necessary to establish the account and/or effectuate payments through the account. User transaction application 152 may further allow the user to service and maintain the payment account, for example, by adding and removing payment instruments.

User transaction application 152 may be used to provide a payment for a transaction between the first user and the second user, for example, where the first user utilizes first communication device 110 to automatically populate contact information for the second user and transmit a processing request for the transaction. Thus, when the first user for first communication device 110 wishes to process a payment or transfer with the second user, first communication device 110 may provide a stored token or other required information (e.g., an identifier) to second communication device 110 and/or transaction processor server 150 for identification of the first user's account, as well as transaction information including the transaction amount, message, etc. Where the first user is paying the second user, the transaction request may identify the account of the second user, for example, using the contact information. However, where the first user requests an amount from the second user, user transaction application 152 may further request an approval for processing the transaction from the second user, a token for identification of a digital wallet and/or a payment instrument, and/or other information necessary to process the transaction. User transaction application 152 may then process the transaction using the received transaction information. User transaction application 152 may utilize data in the transaction information to debit an account of the appropriate user and provide the payment to an account of the other user. User transaction application 152 may also be used to provide transaction histories for processed transactions.

In various embodiments, transaction processor server 150 includes other applications 154 as may be desired in particular embodiments to provide features to transaction processor server 150. For example, other applications 154 may include security applications for implementing server-side security features, programmatic client applications for interfacing with appropriate application programming interfaces (APIs) over network 170, or other types of applications. Other applications 154 may contain software programs, executable by a processor, including a graphical user interface (GUI), configured to provide an interface to the user when accessing transaction processor server 150, where the user or other users may interact with the GUI to more easily view and communicate information. In various embodiments, other applications 154 may include connection and/or communication applications, which may be utilized to communicate information to over network 170.

Additionally, transaction processor server 150 includes database 156. As previously discussed, the first and/or second users may establish one or more digital wallets and/or accounts with transaction processor server 150. Digital wallets and/or accounts in database 156 may include user information, such as name, address, birthdate, payment instruments/funding sources, additional user financial information, user preferences, and/or other desired user data. Users may link to their respective digital wallets and/or payment accounts through an account, user, and/or device identifier or a generated token. Thus, when an identifier or a token is transmitted to transaction processor server 150, e.g., from first communication device 110 and/or second communication device 130, one or more digital wallets and/or payment accounts belonging to the users may be found. Database 156 may also store user data, including detected device data, and transaction information.

In various embodiments, transaction processor server 150 includes at least one network interface component 158 adapted to communicate first communication device 110 and/or second communication device 130 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

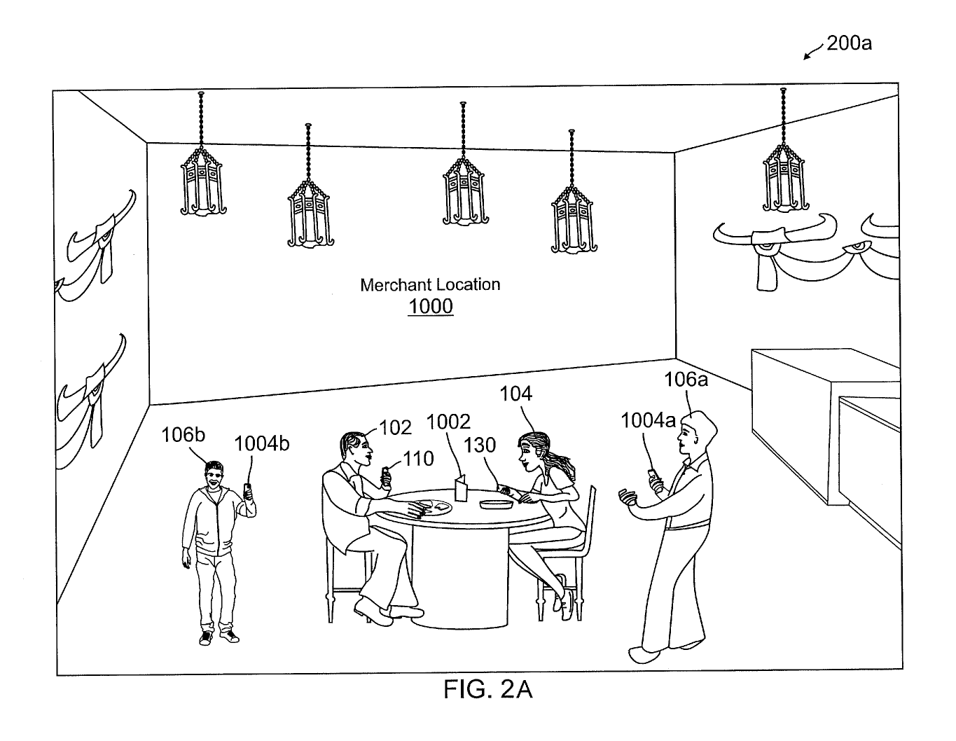

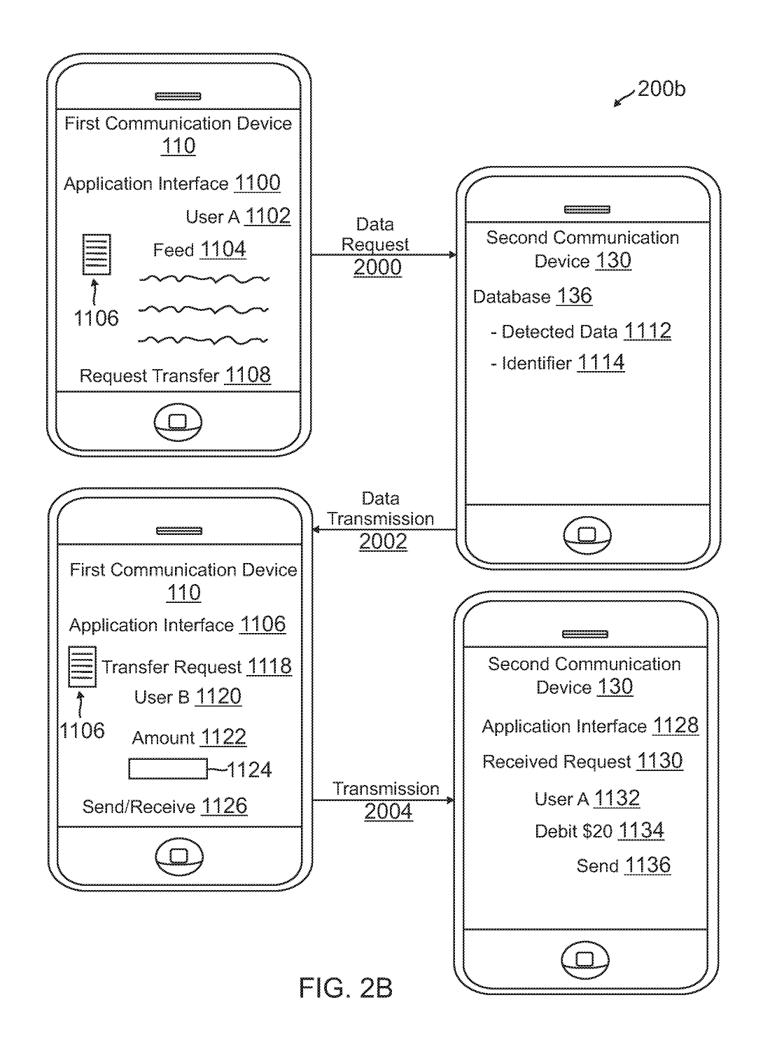

FIG. 2A is an exemplary environment having a first user utilizing a communication device to engage in transaction processing with a second user based on contextually similar detected device data between the first user and the second user, according to an embodiment. FIG. 2A includes an environment 200a of a real-world merchant location 1000 having a first user 102, a second user 104, and two additional users, an ancillary user 106a and an ancillary user 106b. In this regard, first user 102 may utilize first communication device 110 corresponding generally to the described features, processes, and components of first communication device 110 in environment 100 of FIG. 1. Additionally, second user 104 may utilize second communication device 130 corresponding generally to the described features, processes, and components of second communication device 130 in environment 100 of FIG. 1.

For example, first user 102 and second user 104 are shown as located in the same real-world location of merchant location 1000 and are shown to have a physical association or connection based on their seating at a table having a bill 1002. Thus, first user 102 and second user 104 may share a real-world or physical association based on a shared meal at merchant location 1000. In this regard, first user 102 may have paid for bill 1002, and request repayment for the portion of bill 1002 that second user 104 is responsible for repayment. First user 102 is shown utilizing first communication device 110 in order to request the repayment from second user 104. Second user 104 has brought out second communication device 130 in order to receive the transaction request for the repayment from first user 102 and complete the transaction for the repayment. Thus, using data detected by first communication device 110 and/or second communication device 130, the physical or real-world interaction between first user 102 and second user 104 may be determined. For example, first communication device 110 and second communication device 130 may be co-located using GPS or similar location detection technology. Moreover, first user 102 may be detected as requesting or initiating a processing request in an application, which may correspond to the transaction request for a second party (e.g., second user 104). At the same or similar time, second communication device 130 may detect motion or movement of the device when second user 104 places the device on the table. In other embodiments, second user 104 may also activate second communication device 130 or perform a processing request, first communication device 110 and second communication device 130 may form a short range wireless connection, or voice data may be captured of user 102 and/or user 104 to determine the association.

Moreover, and as further discussed herein, based on the contextually similar data between first user 102 and second user 104, ancillary users 106a and 106b may be excluded from selection and determination that ancillary users 106a and 106b have a connection with user 102. For example, ancillary users 106a and 106b may be located far enough from user 102 to lack a real-world or physical connection. Additionally, ancillary users 106a and 106b may utilize different device features, or may not utilize their device at the same time as user 102 (e.g., prior to first user 102 entering the processing request or far enough after that ancillary users 106a and 106b are not attempting to process a transaction with first user 102). In further embodiments, ancillary users 106a and 106b may be excluded as having no previous contact with first user 102 and/or based on a contact list (e.g., that ancillary users 106a and 106b are missing from first user 102's contact list). Thus, such a process to connect first user 102 to second user 104 using detected data by first communication device 110 and/or second communication device 130 in a real-world setting is described further in detail in FIG. 2B, where such a connection may be used to retrieve and auto-populate contact information for second user 104 to an interface viewed by first user 102 on first communication device 110.

FIG. 2B includes exemplary interfaces of a first communication device of a first user and a second communication device of a second user when automatically populating contact information for the second user to the first communication device based on contextually similar detected device data between the first user and the second user, according to an embodiment. FIG. 2B includes an application interface 1100 and an application interface 1116 of first communication device 110, for example, corresponding generally to the described features, processes, and components of first communication device 110 in environment 100 of FIG. 1. In this regard, a first user utilizing first communication device 110 may view application interface 1100 and/or application interface 1116 on first communication device 110, where application interface 1100 and/or application interface 1116 corresponds to an interface (e.g., an operating system interface, application interface, or other graphic user interface) displaying data from an application, such as transaction processing data and/or second user contact information of transaction processing application 120 of first communication device 110 in environment 100 of FIG. 1. Similarly, FIG. 2B includes a database 136 and an application interface 1128 of second communication device 110, for example, corresponding generally to the described features, processes, and components of first communication device 110 in environment 100 of FIG. 1, In this regard, a second user utilizing second communication device 130 may view application interface 1128 on second communication device 130, where application interface 1128 corresponds to an interface (e.g., an operating system interface, application interface, or other graphic user interface) displaying data from an application, such as received transaction processing data of transaction processing application 140 of second communication device 130 in environment 100 of FIG. 1.

The first user may therefore utilize first communication device 110 to enter or initiate a processing request, for example, by opening an application corresponding to application interface 110, unlocking or powering on of first communication device 110, or executing some other process using first communication device 110 that indicates the first user's intent to utilize the processes displayed in application interface 1100, including a process associated with a transaction. Thus, application interface may display a login name for user A 1102, a feed 1104, a navigation tool 1106, and a request transfer option 1108. In various embodiments, the processing request may correspond to selection of the request transfer option 1108, which may then require the first user to enter transaction information, including contact information for the second user. In this regard, first communication device 110 may instead automatically determine and populate the contact information based on detected device data.

In embodiments shown in environment 200b, first communication device 110 may require data in order to determine whether a connection exists between the first user for first communication device 110 and the second user associated with second communication device 130. Thus, first communication device 110 transmits a data request 2000 to second communication device 130, which may include information stored to database 136 that may be utilized to determine a real-world of physical association exists between the first and second users. For example, database 136 is shown storing detected data 1112, such as a text message by the second user, voice data of the first user or the second user, a motion of second communication device 130 or the second user, a biometric of the second user, pairing of second communication device 130 through a short range wireless connection, or a location. Additionally, database 136 may also include an identifier that may be linked to or associated with detected data 1112 for use in retrieving contact information and/or identification of the second user.

Thus, second communication device 130 may respond to first communication device 110 with a data transmission 2002 including detected data 1112 (as well as identifier 1114 in certain embodiments). First communication device 110 may process detected data 1112 in data transmission 2002 to determine identifier 1114 for the second user. However, in other embodiments, first communication device 110 may be capable of singularly, or in combination with second communication device 130, detecting data necessary for determining the association. Once the identifier is determined, first communication device 110 may present application interface 1116. Application interface 116 includes navigation tool 1106, as well as a newly displayed transfer request 1118. Transfer request 1118 may therefore include the loaded contact information using identifier 1114. For example, transfer request 1118 is shown with contact information for user B 1120. Additionally, transfer request 1118 includes interface/form fields for entry of additional information, such as an amount 1122 in a field 1124, and a send/receive option 1126 to determine whether amount 1122 is outgoing or incoming (e.g., requested to be paid by the first user to the second user or request to be paid by the second user to the first user, respectively).

Once the first user has completed transfer request 1118, transfer request 1118 may be transmitted to second communication device 130 in a transfer request transmission 2004. Second communication device 130 may then display application interface 1128 including information for transfer request 1118. For example, application interface 1128 includes a received request 1130 from first communication device 110 that include the displayable transaction information, including identification of user A 1132 and a debit request 1134 for $20. Additionally, application interface 1128 includes a send funds option 1136 to process the transaction and cause a debit of $20 to the second user.

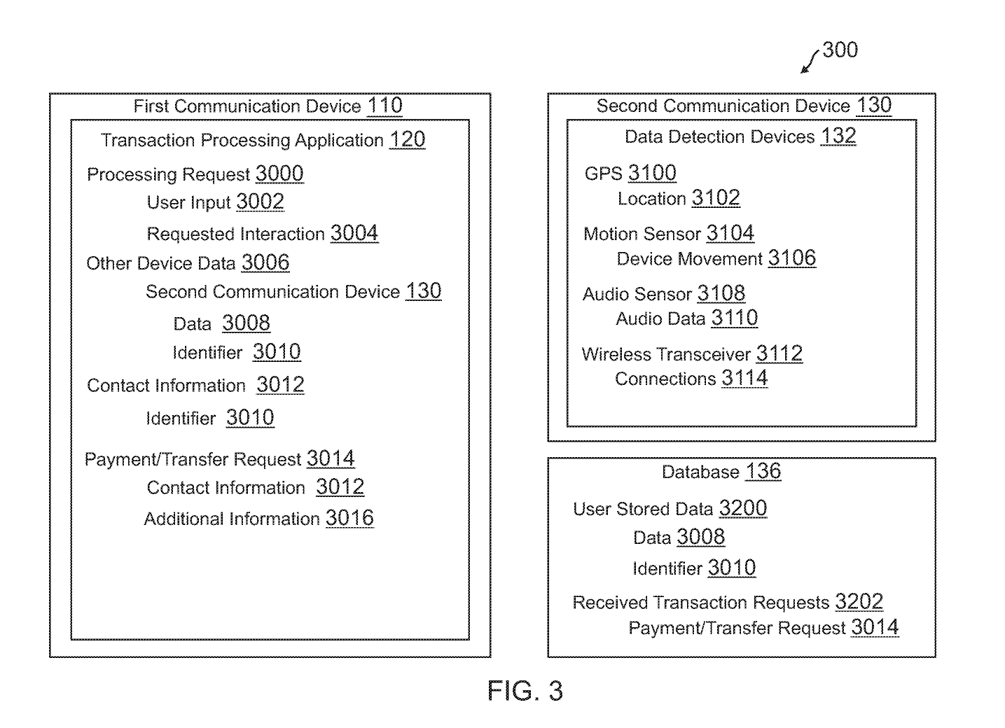

FIG. 3 is an exemplary system environment showing a first communication device and second communication device having data used when automatically populating contact information to the first communication device based on contextually similar detected device data between the first user and the second user, according to an embodiment. FIG. 3 includes first communication device 110 and second communication device 130 corresponding generally to first communication device 110 and second communication device 130 discussed in reference to environment 100 of FIG. 1.

First communication device 110 includes transaction processing application 120 corresponding generally to the processes and features discussed in reference to transaction processing application 120 in environment 100 of FIG. 1. In this regard, transaction processing application 120 includes input, processes, and information used to generate a transaction request for processing. For example, transaction processing application 120 includes a processing request 3000 detected by communication device 110, which may include user input 3002 and may correspond to a requested interaction 3004, such as an application interaction with another user (e.g., a payment/transfer request in transaction processing application 120). In order to determine an entity associated with processing request 3000 and for execution of processing request 3000, transaction processing application 120 may use other device data 3006, for example, data from second communication device 130 including data 3008 and an associated identifier 3010. Once identifier 3010 has been determined based on processing data 3008 to determine that the users associated with first communication device 110 and second communication device 130, identifier 3010 may be used to retrieve contact information 3012, which may be loaded to payment/transfer request 3014. Additional information 3016 may also be input to payment/transfer request 3014.

Second communication device 130 includes data detection devices 132 and database 136 corresponding generally to the devices and stored data utilized by processes and features discussed in reference to second communication device 130 in environment 100 of FIG. 1. In this regard, data detection devices 132 include one or more sensors, components, or other detectors to receive, sense, or determine data, including data for the first user and/or the second user in order to generate an association or connection between the users. Thus, data detection devices 132 include a GPS 3100 detecting a location 3102, such as a current location for second communication device 130. Data detection devices 132 further include a motion sensor 3104, which may detect device movement 3106 for determination of when and if the second user is utilizing second communication device 130. Audio sensor 3108 may capture audio data 3110 of the first and/or second users for co-locating the users or detecting the presence of the other user. Additionally, wireless transceiver 3112 may perform connections 3114 with other devices, including routers or other local area network access devices that may indicate a location and/or first communication device 110 that may indicate a proximity of devices.

Moreover, database 136 includes stored data stored to second communication device 130 for use in determining the association between the first user and the second user. For example, database 136 includes user stored data 3200, which may include data detected by and stored from data detection devices 132. User stored data 3200 includes data 3008 and identifier 3010 previously transmitted to first communication device 110. Database 136 further includes received transaction requests 3202, which includes payment/transfer request 3014 from first communication device 110.

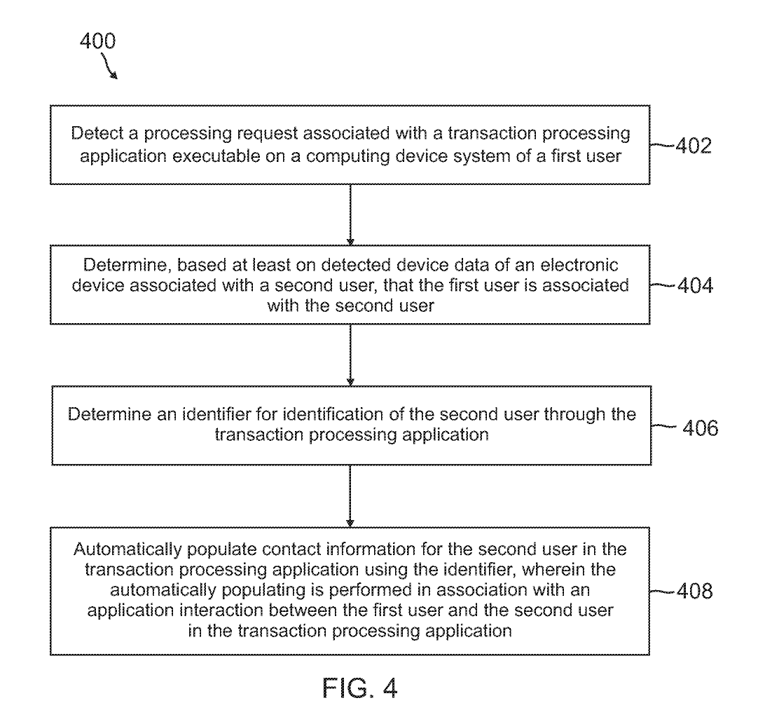

FIG. 4 is a flowchart of one embodiment of a process 400 relating to automatic population of application data using contextual similar real-world data captured by devices, according to an embodiment. Note that one or more steps, processes, and methods described herein may be omitted, performed in a different sequence, or combined as desired or appropriate. In one or more embodiments, all or some of operations of process 400 may be performed by a user computing device such as a smartphone, wearable computing device, etc. In other embodiments, all or some of operations of process 400 may be performed by another computing device.

At step 402, a processing request associated with a transaction processing application executable on a computing device system of a first user is detected. Detecting this processing request, in various embodiments, may include detecting that a user has taken one or more actions with a portable computing device, such as unlocking a smartphone, opening a payment application, opening a web browser to a particular web page or web site, making a particular gesture or motion using or relative to a portable computing device, or providing particular speech input. This detecting, in various embodiments, can therefore be done by a payment application itself, a component of an operating system (such as a user interface module), or another application. The processing request may correspond to an executable process requested by the first user to be performed by the computing device system or in an application of the computing device system. In further embodiments, the processing request may correspond to detected input that may correspond to the executable process requested by the first user. For example, the processing request may correspond to opening of the transaction processing application, unlocking the computing device system, performing a device computing action set for the transaction processing application, a transaction request in the transaction processing application, or a contact lookup request in the transaction processing application.

At step 404, it is determined that the first user is associated with the second user based at least on detected device data of an electronic device associated with a second user. In certain embodiments, the processing request may be associated with a first geo-location detected by the computing device system, where the detected device data may include a second geo-location detected by the electronic device. Thus, the first user may be determined to be associated with the second user when there exists a real-world physical interaction or connection between the first user and the second user, for example, where the first user is co-located with the second user based on matching the first geo-location to the second geo-location (e.g., determining that the first user and the second user are located at the same location, within a proximity to each other, or otherwise share the real-world location at the same or similar times). For example, determining that the first user and the second user are co-located or share a real-world location/interaction may use at least one of activity by the second user within a second transaction processing application executing on the second user's device, data transfer activity by the first user or the second user using their respective devices, a text message by the first user or the second user, voice data of the first user or the second user captured by a device, a biometrics of the first or second user, and/or an electronic pairing of the first user's device to the second user's device through a short range wireless connection. Moreover, the co-location of the first user's geo-location and the second user's geo-location may require a set amount of time, such as an hour, an amount of time dependent on the real-world location, and/or a time of co-location (e.g., during dinner hours).

The detected device data may also include motions and/or movements of the first and/or second users captured by the computing device system for the first user and/or the electronic device for the second user. Thus, determining that the first user is associated with the second user may include determining that the motion or movement occurs in response to the detecting the processing request associated with the transaction processing application.

An identifier for identification of the second user through the transaction processing application is determined, at step 406. In various embodiments, determining the identifier for identification of the second user uses at least one contact list for the first user. For example, the contact list(s) may be taken from at least one of a contact list application used by the first user, a social networking account of the first user, prior contacts of the first user, and additional contacts known to the prior contacts of the first user. Determining this identifier, in various embodiments, may therefore include determining an email address, social networking identifier, unique website or database identifier, or other information that may uniquely identify the second user within the context of usage by the first user of a portable computing device.

At step 408, contact information for the second user is automatically populated in the transaction processing application using the identifier, wherein the automatically populating is performed in association with an application interaction between the first user and the second user in the transaction processing application. For example, the contact information may be presented to the first user in some interface off the transaction processing application, or may be entered to a process of form for the application interaction. Thus, the populating may include one or more of presenting a notification having the contact information within the transaction processing application, entering the contact information into an application form for the application interface, highlighting the contact information in a contact list for the transaction processing application, or bringing the contact information to a top of the contact list. In this regard, the application interaction may correspond to an executable process within the transaction processing application, including a payment request for a payment between the first user and the second user, a fund transfer request between the first user and the second user for a funding amount, a connection request for a connection between the first user and the second user, a data retrieval request for user data or an identifier of the second user, or a message request for a message from the first user to the second user. In one such embodiment, a payment or transfer request may have the contact information populated to a form to send the payment or transfer request from the first user to the second user. Accordingly, a payment or transfer request can be automatically populated to pay or request a transfer of funds from the second user without the first user having to manually browse through a list of contacts to identify a particular individual.

In various embodiments, it may be determined that the processing request comprises the application interaction requiring at least one user based on the processing request. Thus, a plurality of users associated with the application interaction may be determined using a contact list for the first user and device data of devices for the plurality of users, wherein the plurality of users comprise a subset of the contact list. The plurality of users may be displayed to the first user through the transaction processing application, and the first user may be associated with the second user based on a selection of the second user's contact information presented to the first user with the plurality of users. Once the second user's contact information is loaded to the transaction processing application or other application interaction, the first user may enter additional information for the interaction, such as an amount for payment/transfer, whether the amount is outgoing or incoming, a message or other content, or other information. In various embodiments, the additional information may be entered through an image, such as an image of a bill or receipt, where the additional information may be determined using image processing, such as optical character recognition.

In embodiments where the first user is receiving a transaction processing request from the second user, once the contact information is loaded, additional information for the transaction processing request may also be loaded to the transaction processing application. For example, an amount for the payment or transfer request entered by the second user may be loaded to an interface of the transaction processing application. Additionally, if the first user approves the transaction processing request, the amount may be processed and paid or provided to the second user using the contact information. Thus, the processing request entered by the first user may occur after the detected device data, for example, where the first user later wishes to look up the transaction processing request from the second user within the application after the second user sends the transaction processing request. The lookup may occur immediately after the transaction processing request, or may occur at some time after, such as where the first user leaves the real-world environment that the first user shares with the second user (e.g., if the first user heads home after having dinner with the second user and wishes to repay the second user later).

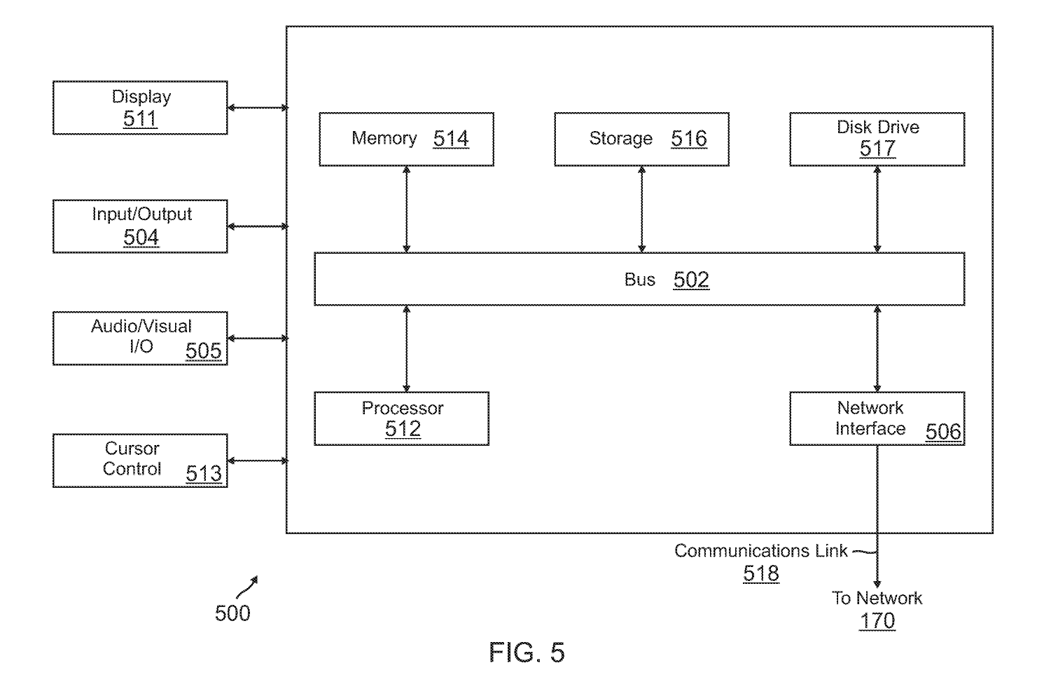

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise Runs or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A computing device system comprising:
a non-transitory memory; and
one or more hardware processors coupled to the non-transitory memory and configured to read instructions from the non-transitory memory to cause the computing device system to perform operations comprising:
detecting a processing request associated with a transaction processing application executable on the computing device system of a first user;
determining, based at least on detected device data of an electronic device associated with a second user, that the first user is associated with the second user;
determining an identifier for identification of the second user through the transaction processing application; and
automatically populating contact information for the second user in the transaction processing application using the identifier, wherein the automatically populating is performed in association with an application interaction between the first user and the second user in the transaction processing application.

2. The system of claim 1, wherein the automatically populating the contact information comprises at least one of presenting a notification having the contact information within the transaction processing application, entering the contact information into an application form for the application interface, highlighting the contact information in a contact list for the transaction processing application, or bringing the contact information to a top of the contact list.

3. The system of claim 1, wherein the processing request is associated with a first geo-location detected by the computing device system, and wherein the detected device data comprises a second geo-location detected by the electronic device, and wherein the determining that the first user is associated with the second user comprises matching the first geo-location to the second geo-location.

4. The system of claim 3, wherein the matching the first geo-location to the second geo-location uses an amount of time that the first geo-location matches the second geo-location.

5. The system of claim 1, wherein the detected device data comprises a movement of the electronic device captured using a motion detection component of the electronic device, and wherein the determining that the first user is associated with the second user comprises identifying that the movement occurs in response to the detecting the processing request associated with the transaction processing application.

6. The system of claim 1, wherein the detected device data comprises information identifying that the first user and the second user are interacting in a real-world environment, and wherein the determining that the first user is associated with the second user comprises determining that the first user and the second user shared the real-world environment at a time of execution of the processing event.

7. The system of claim 1, wherein the operations further comprise, prior to the determining that the first user is associated with the second user:
determining that the processing request comprises the application interaction requiring at least one user based on the processing request;
determining a plurality of users associated with the application interaction using a contact list for the first user and device data of devices for the plurality of users, wherein the plurality of users comprise a subset of the contact list; and
displaying the plurality of users to the first user through the transaction processing application,
wherein the determining that the first user is associated with the second user comprises receiving selection of the second user from the plurality of users displayed to the first user through the transaction processing application.

8. The system of claim 1, wherein the application interaction comprises a payment or transfer request between the first user and the second user, wherein the contact information is populated within an interface of the transaction processing application for processing the payment or transfer request, and wherein the interface comprises at least one field for entry of at least one of an amount for the payment or transfer request or a message accompanying the payment or transfer request.

9. The system of claim 1, wherein the processing request comprises one of opening of the transaction processing application, unlocking the computing device system, performing a device computing action set for the transaction processing application, a transaction request in the transaction processing application, or a contact lookup request in the transaction processing application.

10. The system of claim 1, wherein the application interaction comprises one of a payment request for a payment between the first user and the second user, a fund transfer request between the first user and the second user for a funding amount, a connection request for a connection between the first user and the second user, a data retrieval request for user data or an identifier of the second user, or a message request for a message from the first user to the second user.

11. The system of claim 1, wherein the determining the identifier for identification of the second user uses at least one contact list for the first user, and wherein the at least one contact list is taken from at least one of a contact list application used by the first user, a social networking account of the first user, prior contacts of the first user, or additional contacts known to the prior contacts of the first user.

12. A non-transitory machine-readable medium having stored thereon machine-readable instructions executable to cause a machine to perform operations comprising:
detecting a processing request associated with a transaction processing application executable on a first computing device system of a first user;
determining, based on detected device data of at least one of the first computing device system or a second computing device system associated with a second user, that the first user is associated with the second user;
determining an identifier for identification of the second user through the transaction processing application; and
automatically populating contact information for the second user in the transaction processing application using the identifier, wherein the automatically populating is performed in association with an application interaction between the first user and the second user in the transaction processing application.

13. The non-transitory machine-readable medium of claim 12, wherein the application interaction comprises a payment or transfer request between the first user and the second user, wherein the first user comprises the requestee of the payment or transfer request to the second user, and wherein the second user comprises the requestor of the payment or transfer request from the first user.

14. The non-transitory machine-readable medium of claim 13, wherein the operations further comprise:
loading an amount for the payment or transfer request entered by the second user to an interface of the transaction processing application; and
processing the amount to the second user from the first user using the contact information.

15. The non-transitory machine-readable medium of claim 13, wherein the processing request by the first user is detected after the at least one of the first computing device system or the second computing device system captures the detected device data.

16. The non-transitory machine-readable medium of claim 15, wherein the detected device data comprises a first action performed by the second user using the second computing device system, wherein the processing request further comprises a second action performed by the first user using the first computing device system, and wherein the determining that the first user is associated with the second user comprises matching the first action to the second action.

17. A method comprising:
detecting a processing request associated with a first transaction processing application executable on a first computing device system of a first user;
determining, based on a first geo-location of the first computing device system and a second geo-location of a second computing device system associated with a second user, that the first user and the second user are co-located at a real-world location;
in response to the determining that the first user and the second user are co-located, determining an identifier for identification of the second user through the first transaction processing application; and
automatically populating contact information for the second user to a payment or transfer command in the first transaction processing application using the identifier, wherein the contact information is automatically populated to the payment or transfer command when the first user and the second user are co-located.

18. The method of claim 17, wherein the determining that the first user and the second user are co-located further uses at least one of activity by the second user within a second transaction processing application executing on the second computing device system, a motion of the second computing device system by the second user captured by a motion detector of the second computing device system, data transfer activity of the second computing device system, a text message by the first user or the second user, voice data of the first user or the second user captured by the first computing device system or the second computing device system, a movement detected by the first computing device system or the second computing device system, a biometric detected by the first computing device system or the second computing device system, or an electronic pairing of the first computing device system and the second computing device system through a short range wireless connection.

19. The method of claim 17, wherein the determining that the first user and the second user are co-located comprises determining that the first geo-location and the second geo-location are within a defined proximity for co-locating the first user to the second user for a set amount of time.

20. The method of claim 17, further comprising:
determining transaction information for the payment or transfer command using a past transaction of the first user; and
automatically populating the transaction information for the payment or transfer command to the first transaction processing application,
wherein the processing request comprises imaging of a bill for a transaction by the first user, and wherein the determining that the first user is associated with the second user comprises using optical character recognition or image processing on the bill to determine that the application interaction comprises a split bill request for the bill with the second user.
